(19) United States
(12) Patent Application Publication
(10) Pub. No.: US 2007/0271104 A1
(43) Pub. Date: Nov. 22, 2007

(54) STREAMING SPEECH WITH SYNCHRONIZED HIGHLIGHTING GENERATED BY A SERVER

(76) Inventor: Martin McKay, Belfast (IE)

Correspondence Address: Brian L. Michaelis;Brown Rudnick Berlack Israels LLP, One Financial Center, Box IP, Boston, MA, 02111, US

(21) Appl. No.: 11/750,414

(22) Filed: May 18, 2007

Related U.S. Application Data
(60) Provisional application No. 60/801,837, filed on May 19, 2006.

(51) Int. Cl. G10L 11/00

(52) U.S. Cl. 704/270.1

(57) ABSTRACT

A speech synthesis system and method including an application consisting of two networked parts, a client and a server, which uses the capabilities of the server to speech enable a client that does not have speech capabilities. The system has been designed to enable a client computer with audio capabilities to connect and request text to speech operations via a network or internet connection.

### CROSS REFERENCES TO RELATED APPLICATIONS

This application claims priority to U.S. Provisional Application No. 60/801,837 filed on May 19, 2006.

### FIELD OF THE INVENTION

The present invention relates to distributed computer processes and more particularly to server based speech synthesis.

### BACKGROUND OF THE INVENTION

There are a number of current methods to deliver text to a client computer. For example pre-recorded speech can be delivered from a server without synchronized highlighting; that is, speech can be pre-recorded and stored on a server for access by clients at a later time. This text could be generated by a text to speech engine, or it could take the form of a recording of a human voiceover artist. This pre-recorded audio can then be downloaded to the client or streamed from the server.

Pre-recorded speech can be delivered from a server with synchronized highlighting. This is generated in a similar fashion to delivery of pre-recorded speech without synchronized highlighting, but an additional production stage is required to generate the timing data so that each individual word can be highlighted as it is spoken. Generation of this timing data can be a manual process, or it can be calculated automatically by software.

Speech technology can be deployed to the client computer. In this case, the user must install a text to speech engine on their client computer. The client application then uses this speech technology to produce an audio version of text. It may also perform highlighting.

Each of the existing state-of-the-art solutions have specific drawbacks. Pre-recorded speech delivered from a server without synchronized highlighting is not practical for dynamic content such as, content on a web site, client application or other system that is not fixed. Examples include completion of forms or other interactive features on a website where the publisher is not in complete control of what text should be spoken. In such a system the user generally has little control over how the returned text is spoken by the system. Furthermore, the user does not get synchronized highlighting of the text as it is spoken, therefore not improving their comprehension of the text.

Similarly, pre-recorded speech delivered from a server with synchronized highlighting is not practical for dynamic content such as, content on a web site, client application or other system that is not fixed. Such implementations are not practical for completion of forms or other interactive features on a website where the publisher is not in complete control of what text should be spoken. As with unsynchronized highlighting the user generally has little control over how the returned text is spoken by the system. Additionally, generally, calculation of speech synchronization data, defining when to highlight each word in the text, is a labor-intensive, manual process.

With deployment of speech technology to the client computer a suitable, robust method of deploying the text to speech software must be implemented. The user must install text to speech engines as part of this solution. High quality speech requires a large initial download. Distributing high quality text to speech engines typically incurs a royalty per user. If a variation in the voice is required, such as male and female, or different accents of languages, the user must download and install one text to speech engine for each variation, wherein variation can, for example, be in terms of gender, language or accent. Disadvantageously, separate solutions are required for each operating system that needs to be supported. This is unlikely to deliver the same voice on each operating system, resulting in differing experiences for end users. Furthermore, an end user must have the requisite level of access to their computer system to install software. In a commercial or educational environment, this may not be possible due to network policies.

### SUMMARY OF THE INVENTION

Illustrative embodiments of the present invention provide an application consisting of two networked parts, a client and a server, which uses the capabilities of the server to speech enable a client that does not have speech capabilities. The system has been designed to enable a client computer with audio capabilities to connect and request text to speech operations via a network or internet connection.

The client application, in its most basic form, is a program that takes text and communicates with the server application to create speech with synchronized highlighting. The server application will generate the audio output and the timing information. The client can then color the entire text to be spoken in a highlight color, play back the audio output and also highlight each individual word as it is spoken. The client application can be an application installed on an end-user's computer (for example, an executable application on a Windows, Macintosh or other computing device). Alternatively, the client can be an online application made available to a user via a web browser. Still further, the client can be any device that is capable of displaying text with synchronized highlighting and playing back the output audio. The client application may or may not be cross-platform; that is, it may be designed specifically to work with one of the above examples, or it may work on any number of different systems.

The server application is a program that accepts client speech requests and converts the text of the request into timing information and audio output via a text to speech engine. This data is then made available to the client application for speech and synchronized highlighting. The output audio and timing information can be in any one of a number of formats, but the most basic requirements are: ‘output audio’ is the audio representation of the text request; and ‘timing information’ can include, but is not limited to, the data to match the speech audio to the text as the audio is played.

In the illustrative embodiment, the client computer does not require any speech synthesis software or voices to be installed, allowing for complex speech activities to occur on a system previously thought incapable or only capable with a much lower quality speech engine than those the speech server could use. An application can be required to perform the required client-side operations for this service, but such an application would be much smaller and could be designed to not require installation.

The client computer can be connected to the speech server system via a network (or internet) connection and can request the speech server to render text to speech. The server can then return the required data to the client containing the audio that the client uses to ‘speak the text’.

Features of the speech and highlighting system according to the invention include a system wherein the speech audio required should not need to be pre-recorded; and the text should not need to be ‘static’ or read in any prescribed order. Speech and synchronization information in the system according to the invention should be generated automatically, and text should be highlighted as it is spoken in the client application. No installation of client side speech engines should be required, which allows for scalability. The speech solution according to the invention should be capable of being used in a cross-platform application. Further, advantageously, the client computing device can be of a specification normally incapable of storing the required speech engines and performing the text to speech request with the required speed and quality (e.g., it can lack storage space, processing power etc.).

Additionally, the system according to the invention provides a means to adjust speech or pronunciation of text. The server could have multiple speech engines installed allowing speech variation on the client side without additional client side effort or cost. Use of the solution should not require any specialized knowledge of speech technology, and it should be technically simple for a publisher to implement the speech as part of their overall solution.

### BRIEF DESCRIPTION OF THE DRAWINGS

The foregoing and other features and advantages of the present invention will be more fully understood from the following detailed description of illustrative embodiments, taken in conjunction with the accompanying drawings in which:

FIG. 1 is a sequence diagram of a single operation of a speech server which involves one client making one request and receiving one response according to an illustrative embodiment of the invention;

FIG. 2 is an example of dual color or shading highlighting according to the invention;

FIG. 3A is an example of timing information; and

FIG. 3B is an example of a file format for timing information.

### DETAILED DESCRIPTION

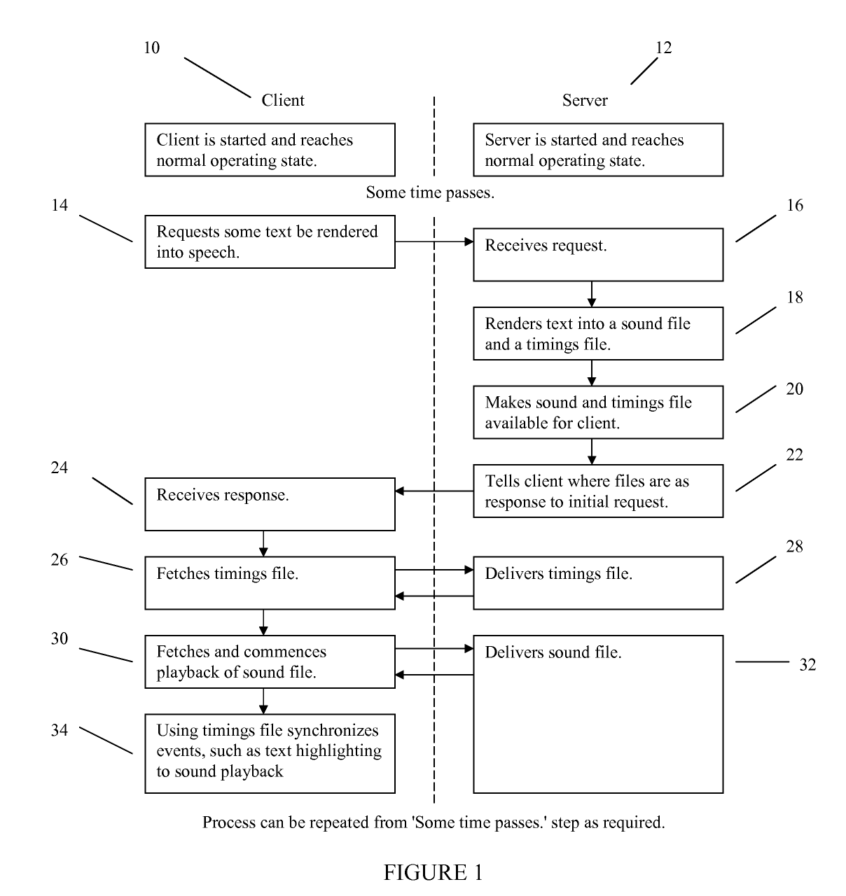

The streaming speech with highlighting implementation generally includes a client application (FIG. 1, 10) and a server application (FIG. 1, 12). Generally, the client application is responsible for (in sequence): determining what text the user wants to have spoken and highlighted; converting this text to a format suitable for communication with the speech server; and determining any control that the user needs to apply to the speech, including (but not limited to) speed of speech and any custom pronunciation. The client application may be permitted to specify where each individual word break occurs for synchronized highlighting. The client application will send the text and control information to the server, wait for a response from the server, obtain the audio output and the highlight information from the server, and play the audio output and simultaneously highlight the words as they are spoken.

The client application may permit the user to customize speech in a number of ways. These include (but are not limited to): which text to speech engine is preferred (to specify gender of the voice, accents and language and other variable if desired); speed of the generated speech; pitch or tone, or other audible characteristics of the generated speech; modification of text pronunciation before it is sent to the server. Any such settings are on a per-user basis; that is, if one user changes a pronunciation or speech setting, it will not affect any other users of the server.

Generally, the server application is responsible for, waiting for a speech request from a client. The speech request will consist of at least, the text to be converted to audio output, e.g. directly or as an audio output file, and optionally, information to tailor the speech generation to the user's preference. The server application will then apply any server-level modifications to the text before conversion to audio (for example, apply a global pronunciation modification to the text), generate the audio conversion of the text using a text to speech engine (as known in the art), and then extract the timing information for each word in the text from the text to speech engine. The server application will then return the audio conversion and the timing information to the Client Application.

An illustrative embodiment of the invention is described more specifically with reference to the sequence diagram provided in FIG. 1 which describes a single operation of the speech server wherein a client makes a request and receives a response.

These mechanisms would produce performance enhancements, but are a ‘transparent’ process that when used during a request would produce otherwise identical results to a request without caching. A client 10 and server 12 which are in communication with each other are started and allowed to reach their normal operating state. In a send request step 14, the client requests that some text be rendered into speech. In a receive request step 16, the server receives the request. In a render step 18, the server renders text into a sound and a timings file. In a file preparation step 20, the server makes the sound and timings file available for clients. In a notification step 22, the server tells the client(s) where the sound and timings files are located as a response to the client's initial request.

In a receive response step 24, the client receives the server's notification. In a fetch step 26 the client fetches timings files from the server while in a deliver step 28, the server delivers the timings files to the client. In a playback step 30, the client fetches and commences playback of the sound file while in a sound file delivery step 32, the server delivers the sound file to the client. In a synchronization step 34, the client uses the timings file to synchronize events such as text highlighting to sound playback. In illustrative embodiments of the invention, the process from the send request step 14 to the synchronization step 34 can be repeated. A caching mechanism can be provided on either or both sides of the embodiment described with reference to FIG. 1.

The speech audio can be produced in whatever format is most suitable for the task. Typically, a text to speech engine will generate an uncompressed waveform output, but this may vary depending on the text to speech technology being utilized.

One example of a text to speech engine is Microsoft's SAPI5. This can provide speech services from a wide range of third party speech technology providers.

This audio output will usually be converted to a compressed format before it is transmitted to a client application, in order to reduce the download time and bandwidth. This will also result in improved response time for the user.

One example of a suitable compression format for transmission of audio data is the MP3 file format.

Once the speech audio has been produced the timing information, detailing when each word occurs in the timeline of the audio output, is extracted from the audio output file.

The information is then converted into a timing information file separate to the speech audio file. The file gives the information relating the text annotations to a precise time offset from the start of the file.

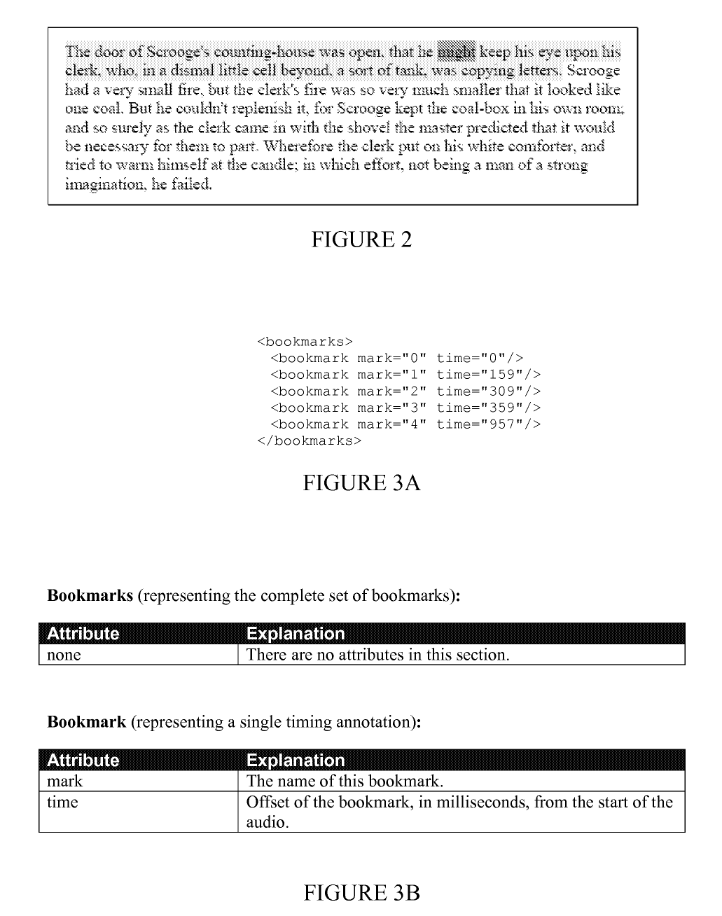

An example of timing information produced from supplied text can be seen in FIG. 3A. FIG. 3A is an example of the kind of response the server application could produce for the annotated text given in the example in FIG. 2. It uses XML for formatting, but could be designed using any suitable format, as long as the client can extract the timing information. The data stored in this simple file format is summarized in the data structure illustrated in FIG. 3B.

The server application may customize or control speech in a number of ways. These include (but are not limited to): application of pronunciation to the supplied text before it is sent to the text to speech engine. For example, logic could be applied to read email addresses or website URLs correctly. The server application may be used to normalize the speed, volume or other characteristics of the speech request to suit a specific speech engine, ensuring that the user gets a similar experience for all text to speech engines, and it may be used to customize pitch or tone, or other audible characteristics of the generated speech

Any such settings are on a global or semi-global basis; that is, they will affect all users (or a group of users) who are using the server.

In illustrative embodiments of the invention, the client, in addition to ‘speaking the text’, can receive information from the speech server to allow synchronisation of events with the speech audio. These events can include (but are not limited to) speech or word start/end events. These can be used to highlight or display the matching text in time the speech being played.

Another example event type would be ‘mouth shape’ events that would allow the client to produce a simulation of a mouth saying the words in time with the audio. This can be useful for speech therapy.

In addition to the basic processing of text to speech and synchronisation events, both sides of the network connection (the client and the server) can include, but do not require, a caching mechanism to improve performance in various ways.

A server side cache can be used to reduce the required work converting text to speech that has been performed previously. This in turn can be used to decrease the time for a response to a client's request. The server can respond with a cached result usually much quicker than performing the rendering process again.

Generation of speech using a text to speech engine is computationally expensive. Overheads can be high, particularly when many client applications are requesting speech simultaneously.

To alleviate this problem, a server can implement a cache to reduce overheads. Each time a user makes a speech request, the resultant output audio and timing information can be stored on the server.

Should a client application make a speech request for the same text, with the same speech control settings as a request that has been made previously, the server can simply return the pre-existing audio file and timings information, without the requirement to regenerate the speech each time.

The server application would also need logic to control the consumption of the limited storage capabilities of the computing device that is being used. When the storage limit of a cache is reached, the server application will release space by removing the oldest, least frequently accessed data from its cache.

A client side cache can be used to reduce network usage by holding previously requested server responses and thus giving the client computer access to these responses without the needs for further communication with the speech server.

The caching mechanisms could be tuned to various conditions to take into account limits of storage space on either the client or server side. For example, it could be advantageous to hold a popular request in a cache longer than a request that was only made once.

Using any network application has disadvantages with regard to network speed and reliability. This can be a particular problem with computing devices using slow speed connections such as modems, to give one example.

In order to alleviate this, the client application can be designed with a ‘cache’. This is a mechanism where-by the application keeps a local copy of responses to previously made requests.

Should the user make a request that would produce a response that is already in the cache, the local copy is re-used without contacting the server application. The design of the client application would need to include logic to determine if a response should be re-used.

The client application would also need logic to control the consumption of the limited storage capabilities of the computing device that is being used. When the storage limit of a cache is reached (it is full) it would be up to the client application to determine which of the files to remove from the cache to enable another file to replace it.

The logic used to determine which files to remove could be based on several attribute such as, for example, file age, frequency of re-use, time of last re-use etc.

Another method of alleviating the disadvantages associated with regards to network speed is the use of ‘file streaming’. This is a process where a file is continuously received by, and consumed by a computing device whilst it is being delivered by a sender.

For example, the client application can make the speech request from a server, and the server can generate the audio output and the timing information for synchronized highlighting. As soon as the audio file is available, it can be downloaded progressively and playback can commence before the complete file has been downloaded.

Implementation of streaming in the client application can therefore minimize response times from the server.

The speech system according to the invention may be configured to implement dual color (or shading) highlighting.

In this example, illustrated in FIG. 2, the sentence is highlighted with light shading (or color for example yellow) to show the context and a second degree of shading, i.e. darker, highlight shows the word currently being spoken. The darker green highlight will move along as each word is spoken whilst the lighter yellow highlight will move as each sentence is spoken.

Part of the design of the speech server system according to illustrative embodiments of the present invention is that it permits multiple clients to connect to one server. This in turn allows the benefits of the speech service being delivered to multiple clients yet only having one point of maintenance.

It should also be noted that the ‘server’, although referred to in the singular, can be made up of multiple machines. This setup allows for the distribution of requests between multiple machines in a request heavy environment with the client machines performing identically to a single machine setup. Having multiple server machines would mean an increase in the speed of responses and make it possible to create a redundant system that would continue to function should a percentage of the server machines fail.

In various illustrative embodiments of the inventive speech server system, alternative configurations or operations could be implemented. For example, the client can be anywhere with a suitable network connection to the server, the client could cache results locally to reduce network traffic or permit off-line operation, the client does not need to use its processing power to produce the speech synthesis. Therefore, it can be of a lower power than is normal for such a system and it would not require royalty payment for the software installed on the server. The client does not need any speech synthesis system installed. Therefore, the client software can be much smaller than normal for such a system. The client does need a small ‘client’ application to perform the requests and handle the responses, however, the system design allows for this application to take various forms, including one that does not require installation, for example by using Macromedia Flash. The timings file can contain multiple types of events. Typically, it contains speech timings events (such as ‘start of word 3’), however it could contain events such as mouth shape events. The client requires the timings information to allow matching of synchronisation events to the audio. However, it is possible to include the timings information as part of the audio file. Doing this would increase communication efficiency. The client can be designed to begin playback of the sound file before it has finished fetching it all. This is called ‘streaming’ playback. The server can have multiple voices. The server can support multiple languages. The server can support multiple clients simultaneously. The server may actually be multiple machines, the software within will be capable of sharing process tasks. When multiple machines are used it is possible that the machine that produces the speech and timings files is different to the machine that serves those files to the client. The speech request (from the client) can be an HTTP request. The speech response (from the server) can be an HTTP response. Using HTTP requests and responses allow for operation of the applications through a typical network firewall with no or minimal changes to that firewall. The timings file can be an XML file, but need not be. The sound file can be an MP3 file, but need not be.

Although the invention has been shown and described with respect to exemplary embodiments thereof, various other changes, omissions and additions in the form and detail thereof may be made therein without departing from the spirit and scope of the invention.

What is claimed is:

1. A speech synthesis system provided in a client/server architecture, the system being configured to provide an audio playback to a user of a provided data file, the system comprising:
a server configured to receive a data file, render the data file into a rendered audio file and to provide said rendered audio file to a client, wherein said sound file provides a spoken representation of the data file; and
a client in communication with said server, said client being configured for sending a data file to said server, to receive said rendered sound files from said server and playback said sound file to a user.

2. A system as claimed in claim 1, wherein the server is configured to generate timing information associating contents of the data file with contents of the rendered sound file.

3. A system according to claim 2, wherein the timing information correlates locations with the contents of the data file to corresponding locations in the rendered sound file.

4. A system according to claim 2, wherein the timing information is provided in a separate file to said rendered sound file.

5. A system according to claim 2, wherein the timing information is provided in the rendered sound file.

6. A system according to anyone of claims 2, wherein the client is configured to use the timing information to provide a synchronised highlighting of the text as sound is played back.

7. A system according to anyone of claims 2, wherein the client is configured to use the timing information to selectively playback portions of the sound file in response to user selection of contents from the data file.

8. A system according to claim 1, wherein the client is configured to accept a user selection of a portion of text within a source data file to render to audio, said selection being provided to the server for subsequent rendering.

9. A system according to claim 8, wherein the selection is provided as a separate data file from the source data file.

10. A system according to claim 8, wherein the source data file is provided to the server and the selection is provided as location information in the source data file.

11. A system according to claim 2, wherein the client is configured to allow a user selection of a portion of text within the data file and whereupon playback of the rendered audio file, the client is configured to track the playback of the rendered audio file by highlighting the corresponding portion within the user selected portion of text on a display device associated with the client

12. A system according to claim 11, wherein the user selection of the portion of text is highlighted separately to the tracked playback highlighting.

13. A system according to claim 1, wherein the server includes comparison means configured to compare a received data file with previously received data files which have been rendered into rendered audio files.

14. A system according to claim 13, whereupon upon on making a positive comparison, the server is configured to provide to the client the previously rendered audio file.

15. A system according to claim 1, wherein the server is configured to provide the rendered audio file in a plurality of different variations, the selection of the appropriate variation being user selected from the client device.

16. A system according to claim 15, wherein the variations differ in the audio characteristics of the generated speech.

17. A system according to claim 15, wherein the device is configured to interface with a plurality of clients, the variation of the rendered audio file being defined separately for each client-server interface.

18. A system as claimed in claim 2, wherein the server is configured to generate timing information associating contents of the data file with contents of the rendered sound file for generating events on the client.

19. A system as claimed in claim 18, wherein the generated events represent movement of a mouth on a display associated with the client.
